(19) United States
(12) Patent Application Publication
(10) Pub. No.: US 2014/0003108 A1
(43) Pub. Date: Jan. 2, 2014

(54) MULTI-LEVEL CONVERTER, AND INVERTER HAVING THE SAME AND SOLAR POWER SUPPLY APPARATUS HAVING THE SAME

(71) Applicants: Industry Foundation of Chonnam National University, (US); SAMSUNG ELECTRO-MECHANICS CO., LTD., Suwon (KR)

(72) Inventors: Doo Young SONG, Suwon (KR); Sung Jun PARK, Gwangju (KR); Min Ho HEO, Suwon (KR); Tae Hoon KIM, Suwon (KR); Tae Won LEE, Suwon (KR)

(73) Assignees: INDUSTRY FOUNDATION OF CHONNAM NATIONAL UNIVERSITY, Gwangju (KR); SAMSUNG ELECTRO-MECHANICS CO., LTD., Suwon (KR)

(21) Appl. No.: 13/660,835

(22) Filed: Oct. 25, 2012

(30) Foreign Application Priority Data
Jun. 29, 2012 (KR) 10-2012-0071038

(51) Int. Cl. H02M 7/537; G05F 3/16

(52) U.S. Cl. 363/131; 323/311

(57) ABSTRACT

There is provided a multi-level converter capable of a multi-level converter capable of outputting power having various voltage levels by using a simple circuit with respect to a single input power supply, an inverter having the same, and a solar power supply apparatus having the same. The present invention provides a multi-level converter including a first buck-boost unit having a single power switch switching an input power supply and outputting a first power having a voltage level varied according to the switching of the power switch, a bypass unit outputting a second power having a voltage level of the input power supply, and a second buck-boost unit sharing the power switch with the first buck-boost unit and outputting a third power having a voltage level varied according to the switching of the power switch; an inverter having the same; and a solar power supply apparatus having the same.

### CROSS-REFERENCE TO RELATED APPLICATIONS

This application claims the priority of Korean Patent Application No. 10-2012-0071038 filed on Jun. 29, 2012, in the Korean Intellectual Property Office, the disclosure of which is incorporated herein by reference.

### BACKGROUND OF THE INVENTION

1. Field of the Invention

The present invention relates to a multi-level converter capable of outputting power having various voltage levels, an inverter having the same, and a solar power supply apparatus having the same.

2. Description of the Related Art

As environmental pollution, global warming, and the like, are gradually increasing in seriousness due to depletion in fossil fuels and emissions of carbon dioxide (CO₂), mono-nitrogen oxides (NOx), sulfur oxides (Sox), and the like, from the end of 20th century, the development of and demand for new renewable energy sources have increased. In particular, demand for technological development has increased, due to liability for reductions in the emission of greenhouse gases, based on the Kyoto Protocol, and increases in crude oil prices. Today, the issue of energy resources is directly connected to national security issues and the willingness to reduce carbon dioxide emissions as well as technologies related thereto has been recognized as national competitiveness strategies.

In spite of a disadvantage in terms of low efficiency thereof, among various new renewable energy sources, a photovoltaic (PV) cell (solar cell), providing a clean, inexhaustible energy source and having advantages according with national semiconductor technologies, has been continuously expanded in a national markets recently. In the case of foreign countries, a solar power supply apparatus using the photovoltaic (PV) cell has been commercialized with the leadership of Japan and German based on technical skills and financial power accumulated over a long period of time.

A solar power supply apparatus includes a converter that converts DC power from the photovoltaic (PV) cell into DC power having a predetermined voltage level and an inverter that converts the converted DC power from the converter into commercial AC power as described in Patent Document 1. In this Patent Document, power conversion efficiency of the converter has become the most important issue.

As the capacity of the converter is increased, 2-level topology has mainly been adopted in converter. However, it may be difficult to increase the power conversion efficiency in the converter. Meanwhile, a multi-level converter that has recently been actively researched may have high power conversion efficiency and low rates of harmonic generation and voltage stress in a power switch; however, in this type of multi-level converter, manufacturing costs may be increased due to circuit complexity and increases in the number of required components.

### RELATED ART DOCUMENT

(Patent Document 1) Korean Patent Laid-Open Publication No. 10-2009-0133036

### SUMMARY OF THE INVENTION

An aspect of the present invention provides a multi-level converter capable of providing output power having various voltage levels using a simple circuit, with respect to a single input power supply, an inverter having the same, and a solar power supply apparatus having the same.

According to an aspect of the present invention, there is provided a multi-level converter, including: a first buck-boost unit having a single power switch switching an input power supply and outputting a first power having a voltage level varied according to the switching of the power switch; a bypass unit outputting a second power having a voltage level of the input power supply; and a second buck-boost unit sharing the power switch with the first buck-boost unit and outputting a third power having a voltage level varied according to the switching of the power switch.

The voltage level of the first power of the first buck-boost unit and the voltage level of the third power of the second buck-boost unit may be varied at the same level.

The first and second buck-boost units may stop the outputting of the first and the third powers while operating of the power switch is stopped, and the first and second buck-boost units may output the first and third powers while the power switch is operating.

The voltage level of the first power of the first buck-boost unit and the voltage level of the third power of the second buck-boost unit may be varied according to a duty of the power switch.

The first buck-boost unit may further include: a first inductor charging and discharging energy of the switched power according to the switching of the power switch; a first capacitor charging and discharging the power from the first inductor; and a first diode providing a power transfer path according to the switching of the power switch.

The second buck-boost unit may further include: a second inductor charging and discharging energy of the switched power according to the switching of the power switch; a second capacitor charging and discharging the power from the second inductor; and a second diode providing a power transfer path according to the switching of the power switch.

According to another aspect of the present invention, there is provided an inverter, including: a multi-level converter including a first buck-boost unit having a single power switch switching an input power supply and outputting a first power having a voltage level varied according to the switching of the power switch; a bypass unit outputting a second power having a voltage level of the input power supply; and a second buck-boost unit sharing the power switch with the first buck-boost unit and outputting a third power having a voltage level varied according to the switching of the power switch; and an inverter unit switching the power output from the multi-level converter unit to output AC power.

The inverter unit may switch respective first to third powers to output the AC power.

The inverter unit may switch a sum of the voltage levels of the first to third powers to output the AC power.

According to another aspect of the present invention, there is provided a solar power supply apparatus, including: a multi-level converter including a first buck-boost unit having a single power switch switching an input power supply from a photovoltaic cell and outputting a first power having a voltage level varied according to the switching of the power switch; a bypass unit outputting a second power having a voltage level of the input power supply; and a second buck-boost unit sharing the power switch with the first buck-boost unit and outputting a third power having a voltage level varied according to the switching of the power switch; and an inverter unit switching the power output from the multi-level converter unit to output AC power.

The solar power supply apparatus may further include: a control unit controlling the switching of the inverter unit and the multi-level converter.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram showing a schematic configuration of a multi-level converter according to an embodiment of the present invention;

FIGS. 2A and 2B are circuit diagrams showing a current loop of the multi-level converter according to the embodiment of the present invention;

FIGS. 3A and 3B are graphs showing an output waveform of the multi-level converter according to the embodiment of the present invention; and

FIGS. 4 and 5 are block diagrams each showing a schematic configuration of an inverter having the multi-level converter according to the embodiment of the present invention and a solar power supply apparatus having the same.

### DETAILED DESCRIPTION OF THE EMBODIMENTS

Hereinafter, embodiments will be described in detail with reference to the accompanying drawings so that they can be easily practiced by those skilled in the art to which the present invention pertains.

However, in describing embodiments of the present invention, detailed descriptions of well-known functions or constructions will be omitted so as not to obscure the description of the present invention with unnecessary detail.

In addition, like or similar reference numerals denote parts performing similar functions and actions throughout the drawings.

A case in which any one part is connected with the another part includes a case in which the parts are directly connected to each other and a case in which the parts are indirectly connected to each other with other elements interposed therebetween.

In addition, unless explicitly described otherwise, “comprising” any components will be understood to imply the inclusion of other components but not the exclusion of any other components.

Hereinafter, exemplary embodiments of the present invention will be described in detail with reference to the accompanying drawings.

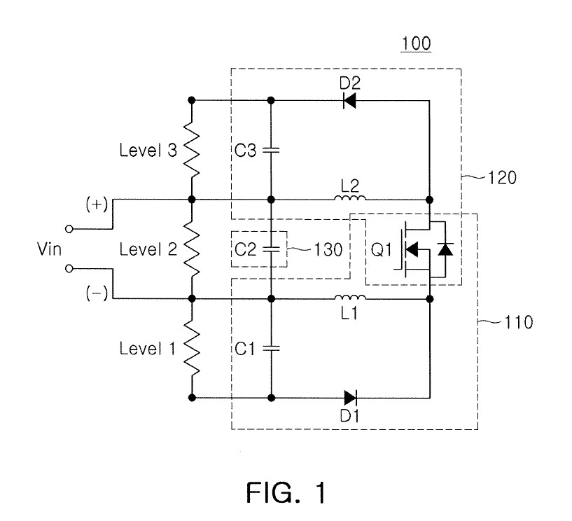

FIG. 1 is a circuit diagram showing a schematic configuration of a multi-level converter according to an embodiment of the present invention.

Referring to FIG. 1, a multi-level converter 100 according to an embodiment of the present invention may include first and second buck-boost units 110 and 120 and a bypass unit 130.

The first buck-boost unit 110 may include a first inductor L1, a first capacitor C1, a first diode D1, and a power switch Q1 for switching an input power supply Vin.

The second buck-boost unit 110 may include a second inductor L2, a second capacitor C2, and a second diode D2, and the second buck-boost unit 120 may share the power switch Q1 for switching the input power supply Vin with the first buck-boost unit 110.

Due to the sharing of the power switch Q1, voltage levels of a first power Level1 and a third power Level3, output from the first and second buck-boost units 110 and 120 may be varied in the same manner.

The bypass unit 130 may bypass the input power supply Vin and output a second power Level2 having a voltage level the same as that of the input power supply Vin as it is. In addition, the bypass unit 130 may include a capacitor C2 that outputs the second power Level2 having a voltage level the same as that of the input power supply Vin as it is.

As described above, the multi-level converter 100 according to the embodiment of the present invention may output the first power Level 1, the second power Level2, and the third power Level3.

Operating of the multi-level converter 100 of the embodiment of the present invention will be described with the reference to the drawings.

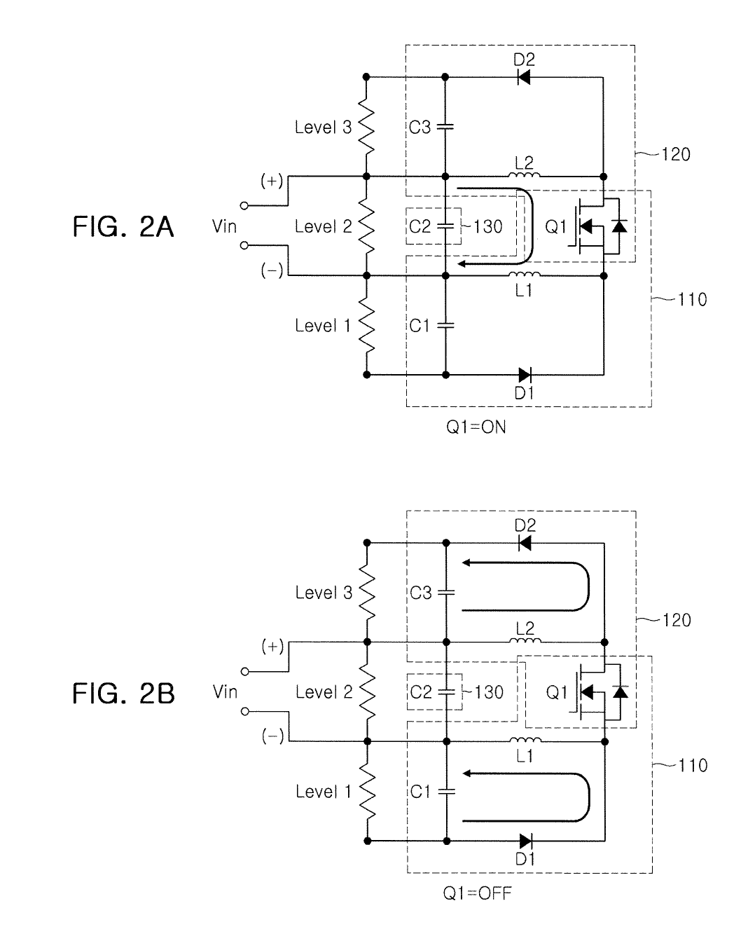

FIGS. 2A and 2B are circuit diagrams showing a current loop of the multi-level converter according to the embodiment of the present invention.

Referring to FIG. 1 and FIG. 2A, a current loop as depicted by an arrow is formed when the power switch Q1 is switched on, and the first inductor L1 and the second inductor L2 may be charged with energy through the current loop formed when the power switch Q1 is switched on.

The bypass unit 130 may output the second power Level2 having a voltage level the same as that of the input power supply Vin, regardless of the switching of the power switch Q1.

Referring to FIGS. 1 and 2B, when the power switch Q1 is switched off, another current loop is formed as depicted by an arrow, and the first capacitor C1 and the second capacitor C3 may be charged with current due to energy charged in the first inductor L1 and the second inductor L2 along a transfer path formed through the first diode D1 and the second diode D2 and output the first power Level1 and the third power Level3.

The first buck-boost unit 110 and the second buck-boost unit 120 may share the power switch Q1, thereby simultaneously outputting the first power Level1 and the third power Level3 or stopping the outputting.

Meanwhile, the voltage levels of the first power Level1 and the third power Level3 may be varied according to switching duty of the power switch Q1. In more detail, the voltage level of the input power supply Vin may be bucked or boosted according to the switching duty of the power switch Q1 to vary the voltage levels of the first power Level1 and the third power Level3.

This will be described in more detail with reference to the accompanying drawings.

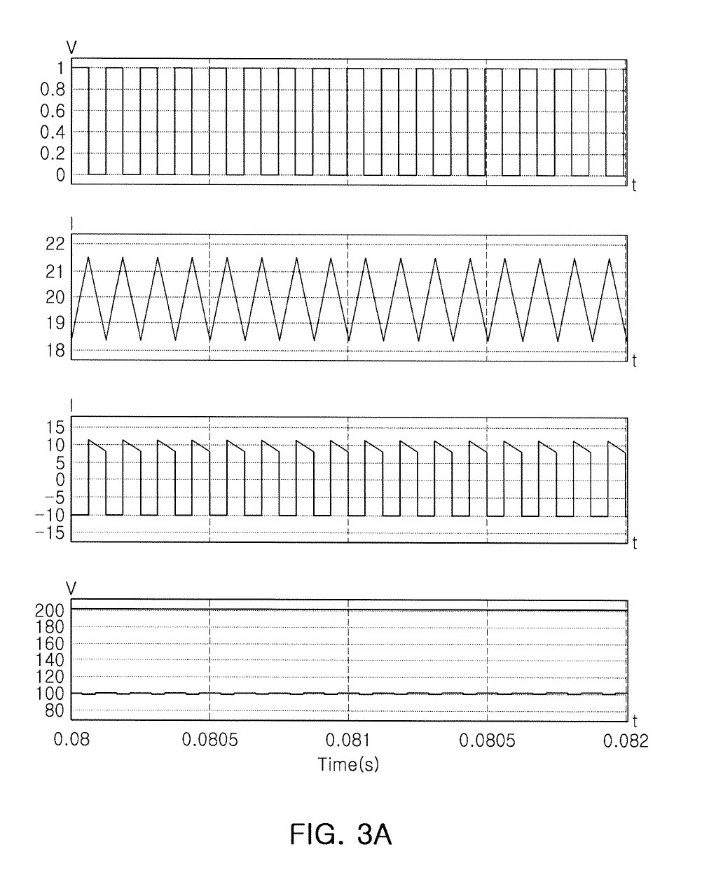

FIGS. 3A and 3B are graphs showing an output waveform of the multi-level converter according to the embodiment of the present invention.

Referring to FIG. 3A, when switching-on duty of a pulse width modulation (PWM) signal applied to the power switch Q1 is small (see first graph), energy charged in the first and second inductors L1 and L2 is reduced (see second graph) and accordingly, the current charged in the first and second capacitors C1 and C3 is reduced (see third graph), such that it can be appreciated that the voltage levels of the first power Level1 and the third power Level3 output from the first buck-boost unit 110 and the second buck-boost unit 120 may be bucked as compared to that of the input power supply Vin (see fourth graph). It can be appreciated from FIG. 3B that the voltage levels of the first power Level1 and the third power Level3 are set to be 100V due to the voltage level of the input power supply Vin being bucked when the input power supply Vin is, for example, 200 V.

On the other hand, referring to FIG. 3B, when the switching-on duty of the pulse width modulation (PWM) signal applied to the power switch Q1 is large (see first graph), energy charged in the first and second inductors L1 and L2 is increased (see second graph) and accordingly, the current charged in the first and second capacitors C1 and C3 is increased (see third graph), such that it can be appreciated that the voltage levels of the first power Level1 and the third power Level3 output from the first buck-boost unit 110 and the second buck-boost unit 120 are boosted as compared to that of the input power supply Vin (see a fourth graph). It can be appreciated from FIG. 3B that the voltage levels of the first power Level1 and the third power Level3 are set to be 400V due to the voltage level of the input power supply Vin being boosted when the input power supply Vin is, for example, 200 V.

As described above, the multi-level converter according to the embodiment of the present invention may output the first power to the third power through a simple circuit configuration with respect to a single input power supply, thereby reducing manufacturing costs thereof.

Meanwhile, the multi-level converter according to the embodiment of the present invention may be adopted in an inverter and a solar power supply apparatus.

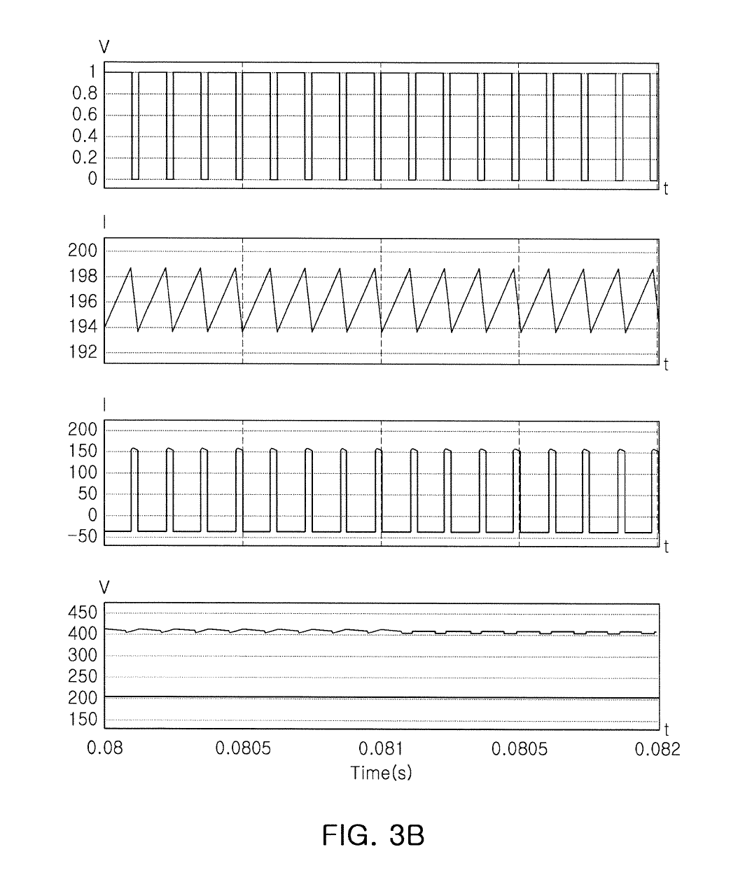

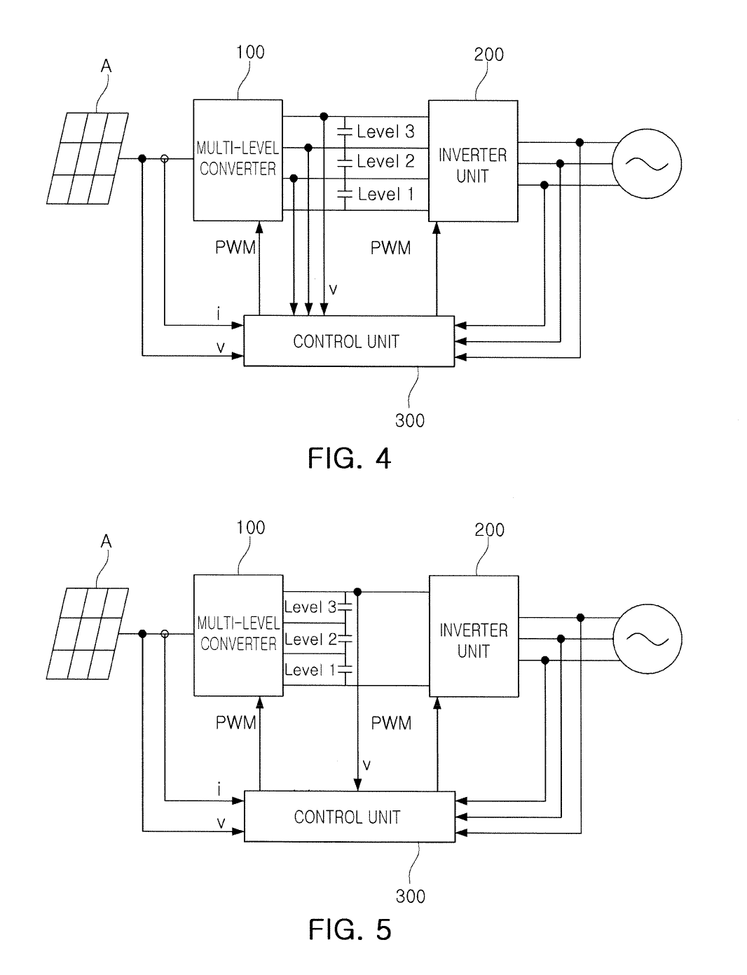

FIGS. 4 and 5 are block diagrams each showing a schematic configuration of an inverter having the multi-level converter according to the embodiment of the present invention and a solar power supply apparatus having the same.

Referring to FIGS. 4 and 5, the solar power supply apparatus including the multi-level converter according to the embodiment of the present invention may include the multi-level converter 100 outputting the first to third powers from a single input power supply coming from a photovoltaic (PV) cell A, an inverter unit 200 outputting AC power by switching the power from the multi-level converter 100, and a control unit 300 controlling the switching of the inverter unit 200.

The multi-level converter 100 and the inverter unit 200 may form a single inverter that converts DC power into AC power.

When the inverter unit 200 is a multi-level inverting type inverter, the inverter unit 200 may receive respective first to third powers Levels 1 to 3 from the multi-level converter 100 and perform switching thereon to convert the switched first to third powers Levels 1 to 3 into AC power, thereby variously setting voltage levels of the AC power (see FIG. 4) and may switch power corresponding to a sum of the first to third powers Level 1 to 3 to convert the switched power into the AC power (see FIG. 5).

The control unit 300 may detect voltage and current of the input power supply from the photovoltaic cell A and utilize the detected voltage and current in controlling an operation of the solar power supply apparatus. The control unit 300 may control a power conversion operation of the multi-level converter 100 and the inverter unit 200 based on output power of the multi-level converter 100 and the inverter unit 200.

As described above, according to the embodiments of the present invention, DC power having various voltage levels may be generated using a simple circuit with respect to a single input power supply and the DC power may be converted into AC power, thereby allowing for a reduction in the manufacturing costs of the inverter and the solar power supply apparatus.

As set forth above, according to the embodiments of the present invention, output power having various voltage levels with respect to a single input power supply can be provided by using a simple circuit, thereby allowing for a reduction in manufacturing costs.

While the present invention has been shown and described in connection with the embodiments, it will be apparent to those skilled in the art that modifications and variations can be made without departing from the spirit and scope of the invention as defined by the appended claims.

What is claimed is:

1. A multi-level converter, comprising:
a first buck-boost unit having a single power switch switching an input power supply and outputting a first power having a voltage level varied according to the switching of the power switch;
a bypass unit outputting a second power having a voltage level of the input power supply; and
a second buck-boost unit sharing the power switch with the first buck-boost unit and outputting a third power having a voltage level varied according to the switching of the power switch.

2. The multi-level converter of claim 1, wherein the voltage level of the first power of the first buck-boost unit and the voltage level of the third power of the second buck-boost unit are varied at the same level.

3. The multi-level converter of claim 1, wherein the first and second buck-boost units stop the outputting of the first and the third powers while operating of the power switch is stopped, and the first and second buck-boost units output the first and third powers while the power switch is operating.

4. The multi-level converter of claim 1, wherein the voltage level of the first power of the first buck-boost unit and the voltage level of the third power of the second buck-boost unit are varied according to a duty of the power switch.

5. The multi-level converter of claim 1, wherein the first buck-boost unit further includes:
a first inductor charging and discharging energy of the switched power according to the switching of the power switch;
a first capacitor charging and discharging the power from the first inductor; and
a first diode providing a power transfer path according to the switching of the power switch.

6. The multi-level converter of claim 1, wherein the second buck-boost unit further includes:
a second inductor charging and discharging energy of the switched power according to the switching of the power switch;
a second capacitor charging and discharging the power from the second inductor; and
a second diode providing a power transfer path according to the switching of the power switch.

7. An inverter, comprising:
a multi-level converter including a first buck-boost unit having a single power switch switching an input power supply and outputting a first power having a voltage level varied according to the switching of the power switch; a bypass unit outputting a second power having a voltage level of the input power supply; and a second buck-boost unit sharing the power switch with the first buck-boost unit and outputting a third power having a voltage level varied according to the switching of the power switch; and
an inverter unit switching the power output from the multi-level converter unit to output AC power.

8. The multi-level converter of claim 7, wherein the voltage level of the first power of the first buck-boost unit and the voltage level of the third power of the second buck-boost unit are varied at the same level.

9. The inverter of claim 7, wherein the first and second buck-boost units stop the outputting of the first and the third powers while operating of the power switch is stopped, and the first and second buck-boost units output the first and third powers while the power switch is operating.

10. The inverter of claim 7, wherein the voltage level of the first power of the first buck-boost unit and the voltage level of the third power of the second buck-boost unit are varied according to a duty of the power switch.

11. The inverter of claim 7, wherein the first buck-boost unit further includes:
a first inductor charging and discharging energy of the switched power according to the switching of the power switch;
a first capacitor charging and discharging the power from the first inductor; and
a first diode providing a power transfer path according to the switching of the power switch.

12. The inverter of claim 7, wherein the second buck-boost unit further includes:
a second inductor charging and discharging energy of the switched power according to the switching of the power switch;
a second capacitor charging and discharging the power from the second inductor; and
a second diode providing a power transfer path according to the switching of the power switch.

13. The inverter of claim 7, wherein the inverter unit switches respective first to third powers to output the AC power.

14. The inverter of claim 7, wherein the inverter unit switches a sum of the voltage levels of the first to third powers to output the AC power.

15. A solar power supply apparatus, comprising:
a multi-level converter including a first buck-boost unit having a single power switch switching an input power supply from a photovoltaic cell and outputting a first power having a voltage level varied according to the switching of the power switch; a bypass unit outputting a second power having a voltage level of the input power supply; and a second buck-boost unit sharing the power switch with the first buck-boost unit and outputting a third power having a voltage level varied according to the switching of the power switch; and
an inverter unit switching the power output from the multi-level converter unit to output AC power.

16. The solar power supply apparatus of claim 15, wherein the voltage level of the first power of the first buck-boost unit and the voltage level of the third power of the second buck-boost unit are varied at the same level.

17. The solar power supply apparatus of claim 15, wherein the first and second buck-boost units stop the outputting of the first and the third powers while operating of the power switch is stopped, and the first and second buck-boost units output the first and third powers while the power switch is operating.

18. The solar power supply apparatus of claim 15, wherein the voltage level of the first power of the first buck-boost unit and the voltage level of the third power of the second buck-boost unit are varied according to a duty of the power switch.

19. The solar power supply apparatus of claim 15, wherein the first buck-boost unit further includes:
a first inductor charging and discharging energy of the switched power according to the switching of the power switch;
a first capacitor charging and discharging the power from the first inductor; and
a first diode providing a power transfer path according to the switching of the power switch.

20. The solar power supply apparatus of claim 15, wherein the second buck-boost unit further includes:
a second inductor charging and discharging energy of the switched power according to the switching of the power switch;
a second capacitor charging and discharging the power from the second inductor; and
a second diode providing a power transfer path according to the switching of the power switch.

21. The solar power supply apparatus of claim 15, wherein the inverter unit switches respective first to third powers to output the AC power.

22. The solar power supply apparatus of claim 15, wherein the inverter unit switches a sum of the voltage levels of the first to third powers to output the AC power.

23. The solar power supply apparatus of claim 15, further comprising a control unit controlling the switching of the inverter unit and the multi-level converter.
